(19) United States
(12) Patent Application Publication
(10) Pub. No.: US 2006/0010487 A1
(43) Pub. Date: Jan. 12, 2006

(54) System and method of verifying personal identities

(76) Inventors: Robert G. Fierer, McDonough, GA (US); James W. Aspinwall, Campbell, CA (US)

Correspondence Address: DLA PIPER RUDNICK GRAY CARY US LLP, P. O. BOX 9271, RESTON, VA, 20195, US

(21) Appl. No.: 11/125,318

(22) Filed: May 10, 2005

Related U.S. Application Data
(60) Provisional application No. 60/586,481, filed on Jul. 9, 2004.

(51) Int. Cl. G06F 15/16

(52) U.S. Cl. 726/5

(57) ABSTRACT

A method and system is provided which verifies the identification of individuals. Multi-faceted personal information is collected from the individual. Next, the personal information is verified. Finally, an identification verification instrument is issued if the personal information has met a predetermined level of verification.

This application claims priority to provisional application 60/586,481 filed on Jul. 9, 2004 and entitled “System and Method of Verifying Personal Identities”. The 60/586,481 provisional application is also incorporated by reference into the current application.

### FIELD OF THE INVENTION

The present invention relates generally to a system and method of verifying personal identity, and specifically to a system and method of verifying personal identity in a manner that utilizes multiple sources of information.

### BRIEF DESCRIPTION OF THE FIGURES

FIG. 1 illustrates a system diagram, according to one embodiment of the present invention.

FIG. 2 illustrates an application process, according to one embodiment of the invention.

FIG. 3 illustrates a method of utilization, according to one embodiment of the invention.

FIG. 4 illustrates examples of hard data and soft data, according to one embodiment of the invention.

FIGS. 5-16 illustrate screen shots, according to one embodiment of the invention.

### DETAILED DESCRIPTION OF EMBODIMENTS OF THE INVENTION

In one embodiment, an identity of an individual is verified based on who they are and what they know. Individuals are asked a series of questions and are asked to provide public and privately held information unique to them. This information is then verified. The information to be verified can establish identity with a high degree of accuracy and confidence, higher than information that is verified using readily available information or documents. Based on how much information can be verified, inclusion or exclusion of the individual within certain classes of confidence are determined, and an identification verification instrument 110 is then issued to an individual. When the individual uses the identification verification instrument 110, only selected portions of the information are used for the purpose of verifying the individual's identity.

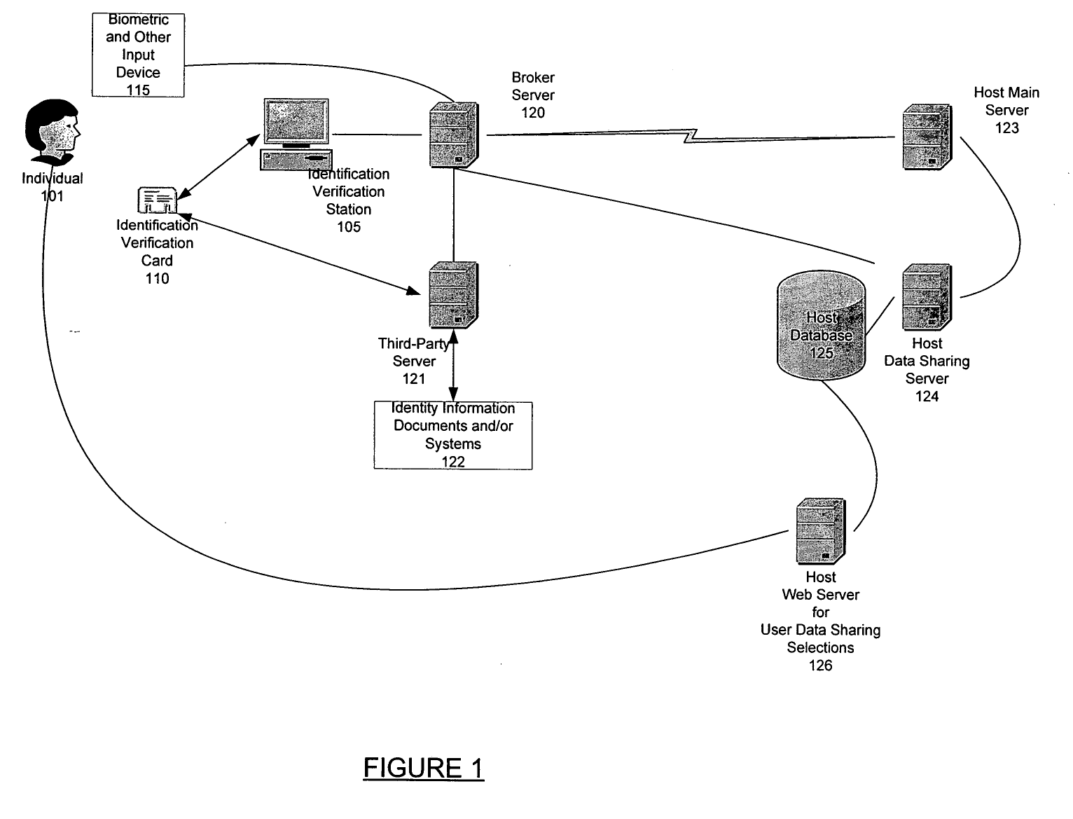

System Diagram. FIG. 1 illustrates a system diagram, according to one embodiment of the present invention. The system comprises at least one identification verification station 105 (e.g., a computer), at least one identification verification instrument 110 (e.g., a smart card), at least one biometric device 115 (e.g., a face camera, retinal scanner, fingerprint pad, document camera, scanner), at least one host database 125, at least one broker server 120, at least one third-party server 121, at least one identity information document and/or system 122, at least one host main server 123, at least one host data sharing server 124, and at least one host web server for user data sharing selections 126.

The identification verification station 105 may comprise a prompting method (e.g., on-screen text or written instructions) to prompt an applicant. The identification verification station 105 is used to receive information from an applicant who wishes to apply for an identification verification instrument. The identification verification station 105 accepts information from the applicant. This information can include basic identification information and other personal information. Those experienced in the art will recognize that the identification verification station 105 is of a flexible configuration, including but not limited to a desk-top computer, a laptop computer, a personal digital assistant (PDA), or a computer present in another device (e.g., a kiosk). The identification stations 105 can thus be applied to numerous situations. The identification verification station 105 can also issue the identification verification instrument 110, although in some embodiments, a component other than the identification verification station 105 will actually issue the identification verification instrument 110.

The identification verification instrument 110 comprises, but is not limited to: “Smart cards”, FLASH memory devices, read-only and read/write magnetic, optical or digital/electronic media, bar coded media, encrypted printed media, optical or digital image formats, cellular phones, or personal digital assistants (PDAs), or any combination thereof.

In one embodiment, the identification verification station 105 can be used in a stand-alone configuration for physical or logic access control systems (e.g., computer, network). The identification verification instrument 110 can be used with a system authorized and enabled to access and query data within the identification verification instrument 110. In one embodiment, the data secured in the identification verification instrument 110 must match at least one of the biometric or manually entered security elements (e.g., a password). In one embodiment, no personally identifiable information is stored in the identification verification instrument, thus thwarting theft/privacy of the identity instrument and replacing the information with fraudulent or substituted date. Further, the biometric data and devices used to store and read it are secured such that tampering may be detected and the identity rendered suspect or invalid.

The broker server 120 accepts information from the identification verification station 105 and the biometric and other input device 115. The information from the biometric and other input device 115 includes information on a credit card, license, or other device storing information; or biometric information submitted through the biometric input device 115; or any combination thereof. The broker server 120 can be configured in a manner that limits access to information based on what the user providing the personal information authorizes.

The host main server 123 receives the personal information from the user entered in the broker server 120. The host main server 123 verifies the personal information by verifying the information itself by checking numerous databases; or sending out the personal information to be verified by an outside entity; or any combination thereof.

The host data sharing server 124 stores information which will appear on the personal identification device 110 in a host database 125. In one embodiment, the third-party user will accept the identification verification instrument 110 on a third-party server 121 that can include specifically authorized secure systems.

In one embodiment, the personal information that is verified by the host main server 123 is not stored on the host data sharing server 124 or the broker server 120. In fact, in one embodiment, a third-party user (e.g., a store, bank) of the identification verification instrument 110 is only able to access or disclose information authorized by the user as determined in the host web server for user data sharing selections 126. In addition, in one embodiment, the personal information provided by the applicant is not even stored, and is discarded after the user's identity has been verified and an identification verification instrument 110 has been issued.

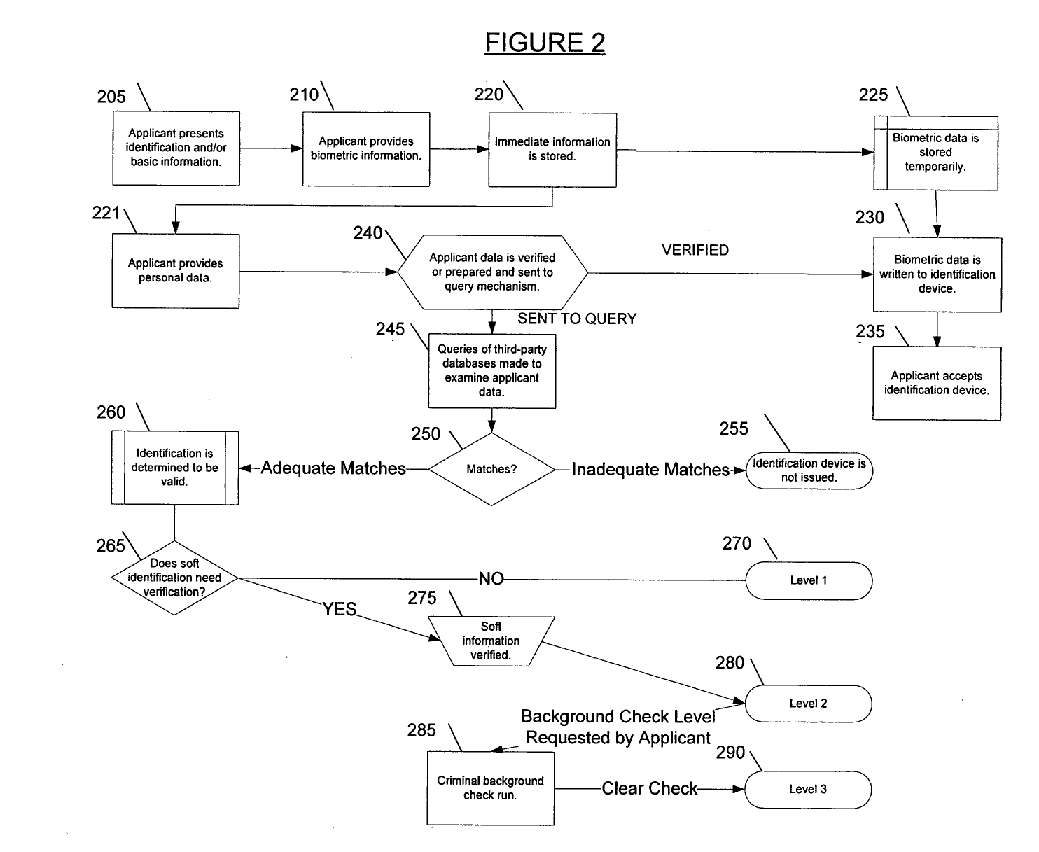

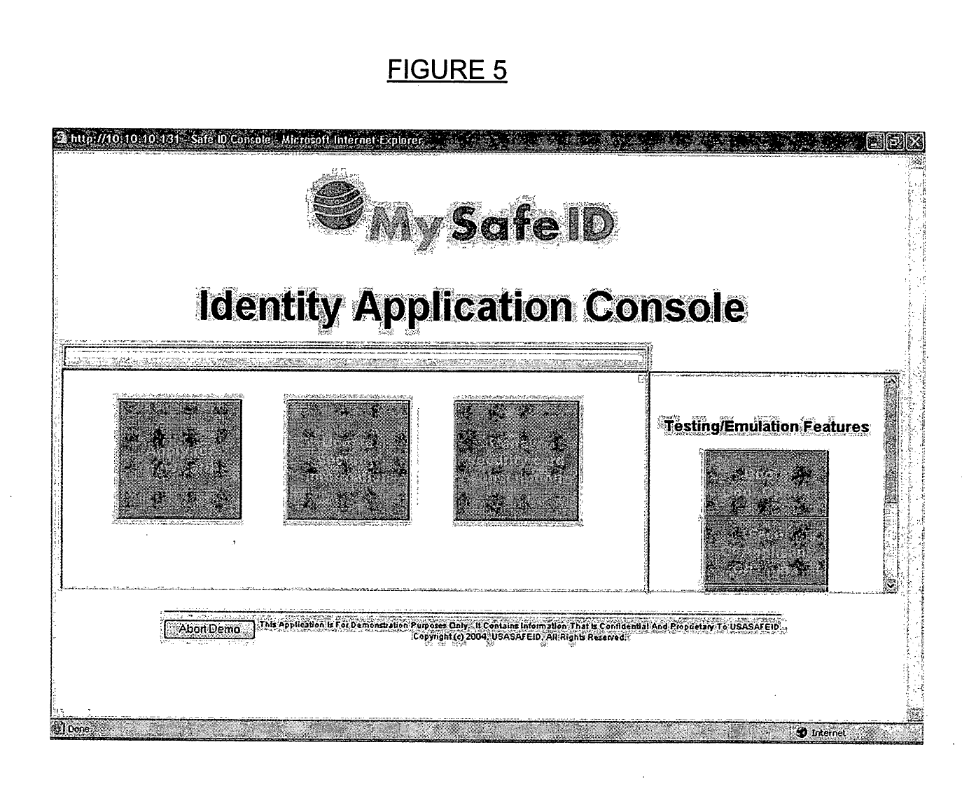

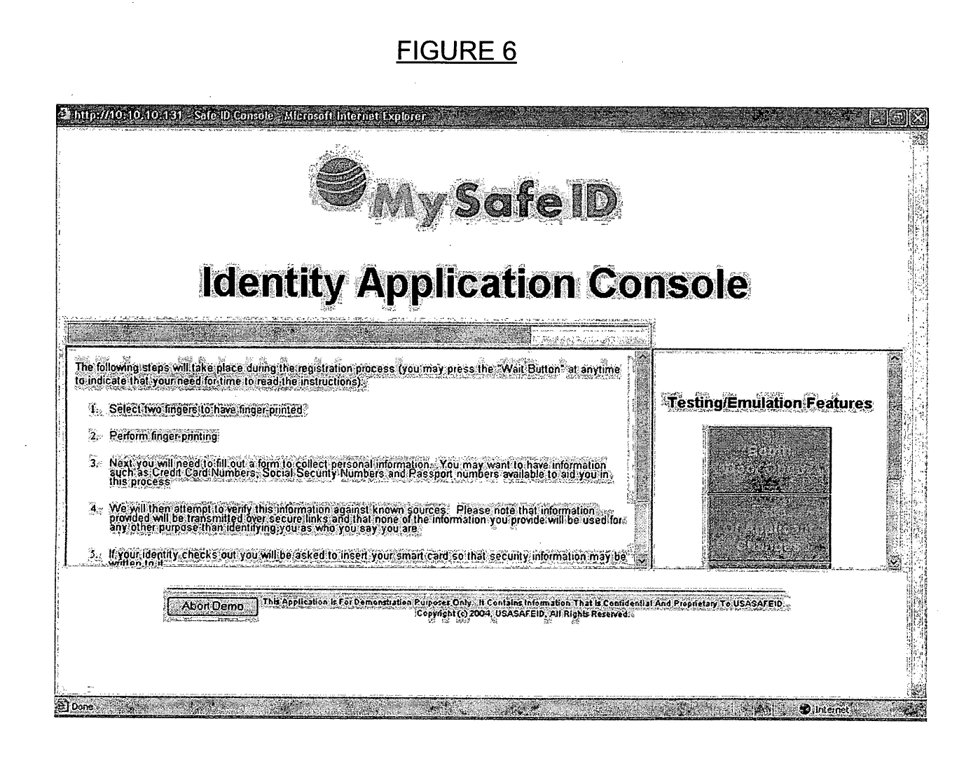

Application Process. FIG. 2 illustrates an application process, according to one embodiment of the invention. At 205, the applicant presents identification information in response to prompts, as illustrated in FIGS. 5-7. FIG. 5 provides prompts for applying for a new card, updating security information, and renewing a card subscription. If the user chooses the apply prompt, the process moves to 210. If the user chooses to update security information, the user is able to change information the user has already entered. If the user chooses to renew the security card subscription, the user is able to renew his subscription by entering additional required information. FIG. 6 provides information on the process and allow the user to continue or stop the application process. The identification information is stored in database 120 in 220. At this point, the applicant can be asked to provide basic personal information to determine if a record about them exists. This can include entering a credit card, license, or other type of device with information stored within, or can simply include answering questions or providing personal information. If the individual exists in the reference data base they are queried about random personal data that in combination should be unique to them. This data comprises, but is not limited to: name, address, driver's license, or social security number, or any combination thereof. If the applicant does not answer the queries successfully, the process ends and an identification verification instrument 110 will not be issued.

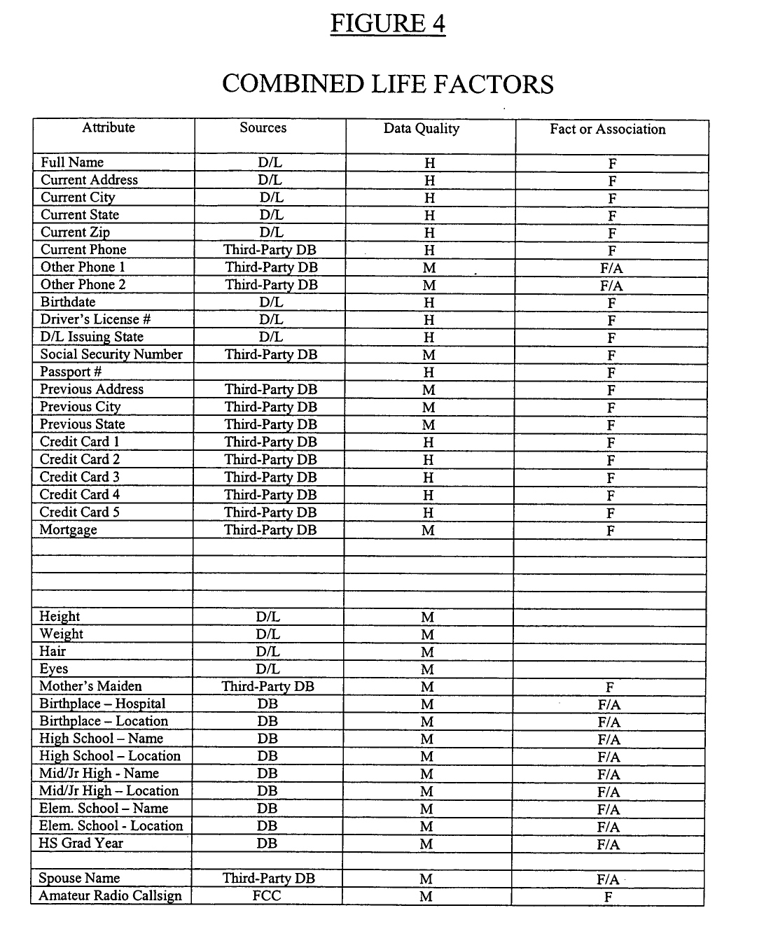

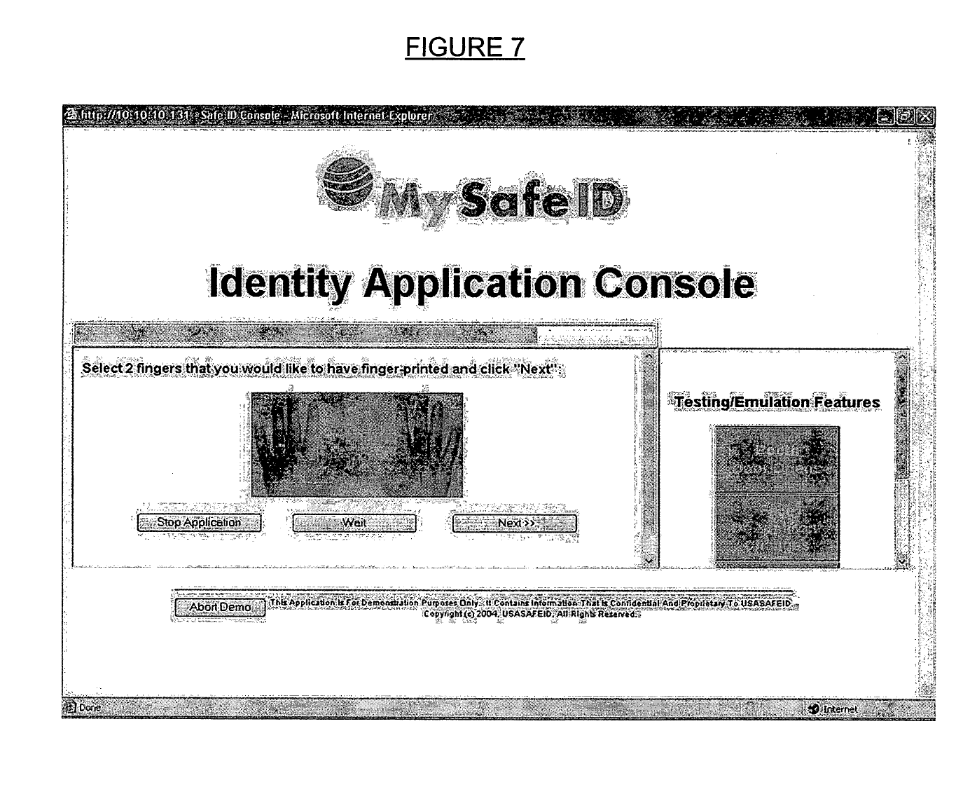

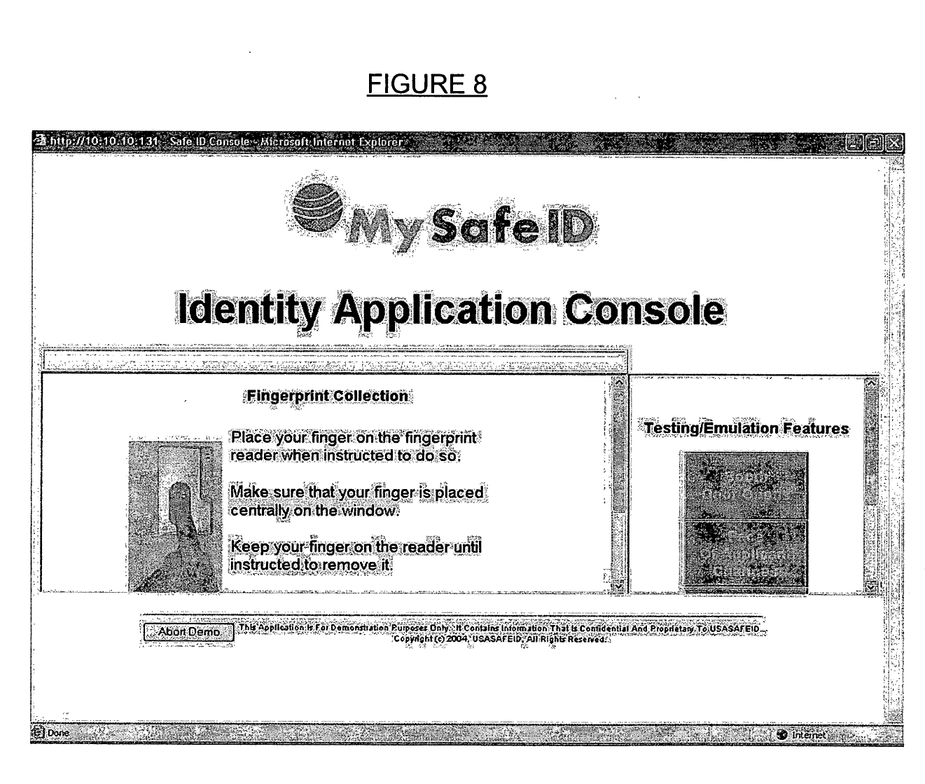

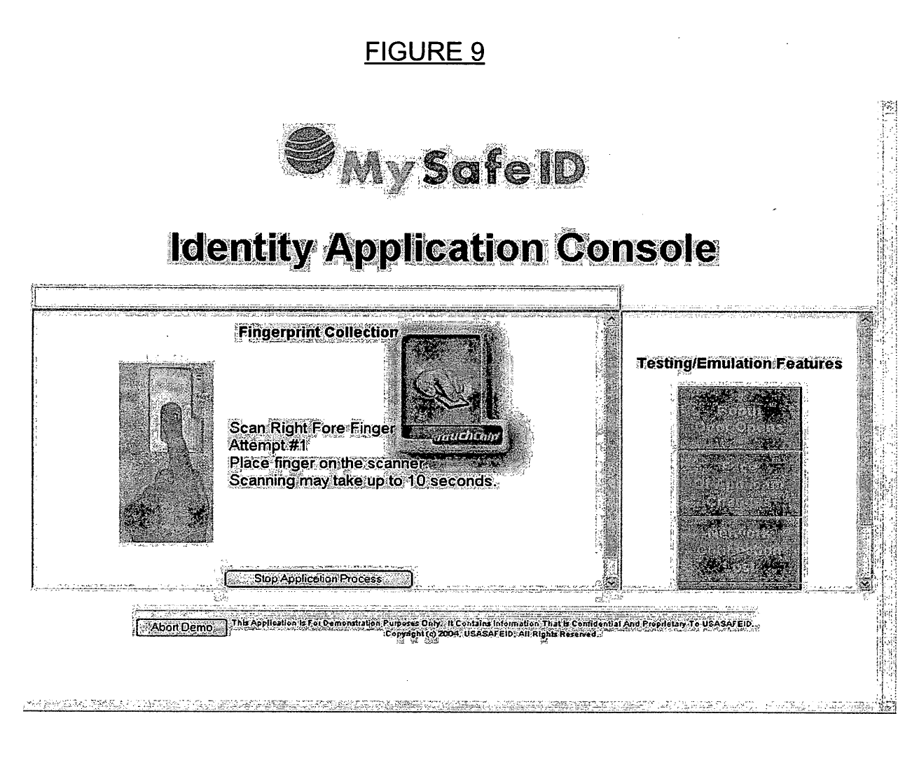

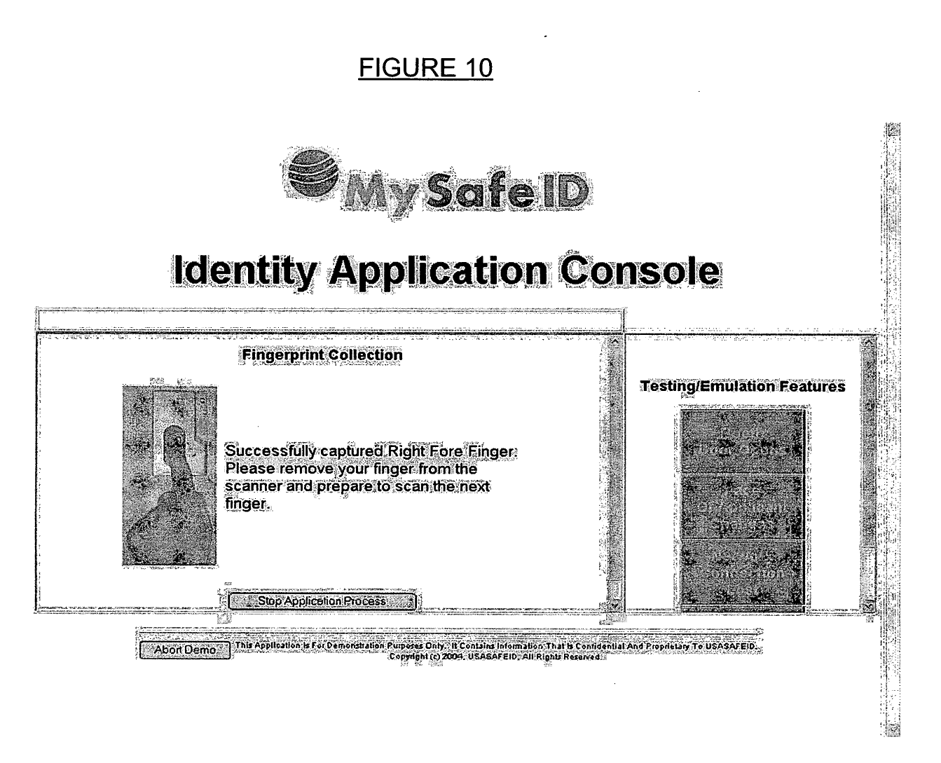

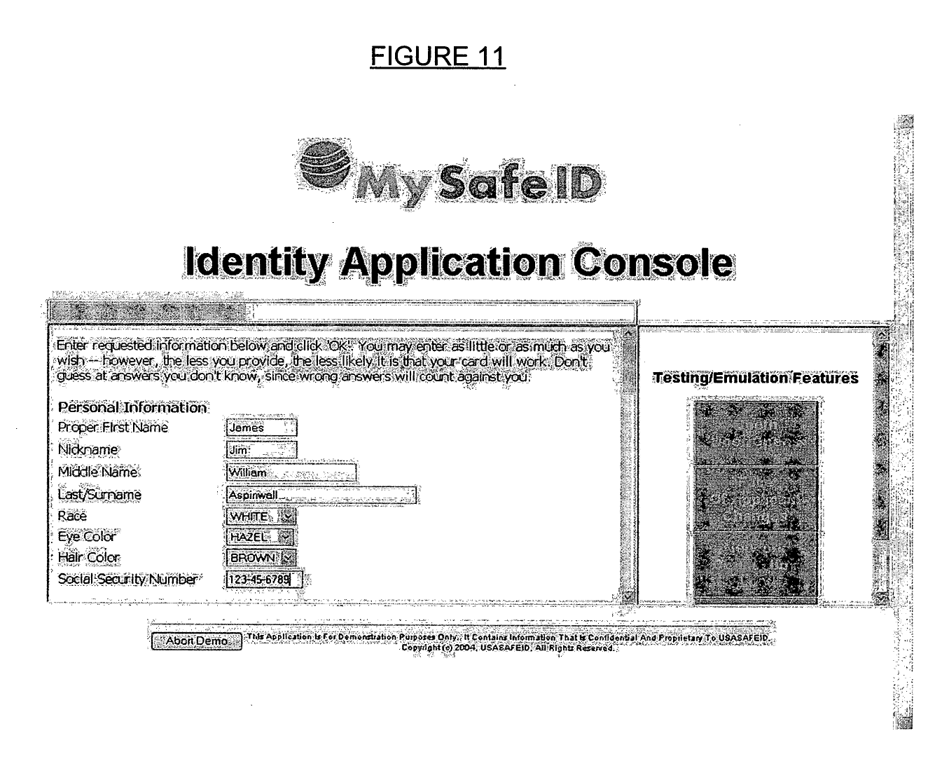

At 210, if the applicant is successful in providing the basic information, the applicant may provide biometric data (e.g., photo, fingerprint, retinal scan), as illustrated in FIGS. 7-10. FIGS. 7-10 prompt for fingerprint data, but any kind of biometric data can be provided. At 225, the biometric data is temporarily stored in a database. At 221, the applicant may provide personal data, as illustrated in FIG. 11. FIG. 11 asks for a small amount of personal data, including a name, nickname, race, eye color, hair color, and social security number. This personal data can either be provided at the time that the applicant applies for the identification verification instrument 110, or the applicant could be prompted for this information at another time. (This option could be added as an additional layer of security.) The personal data can also include multiple questions that are asked to verify the applicant's identity. The questions relate to “hard” data and “soft” data. Hard data is data that is more readily available. Soft data is data that is less readily available. FIG. 4 illustrates examples of hard data and soft data, according to one embodiment of the invention. Hard data includes easily discovered (e.g., by stealing a wallet/purse, reviewing employment records, or searching trash) information about a person. Examples of hard data include full name, current address, and birth date. Hard data is used to isolate known data records of a person for further query of soft data. Soft data includes information that is more difficult to discover about a person without the person providing the information, or without intimate knowledge of the person. Examples of soft data include most/all prior residence addresses, name of elementary/grammar school attended; name of high school attended, and city and hospital of birth. Combined, hard and soft data identify a person with a higher degree of certainty than hard data alone.

As illustrated in FIG. 4, hard and soft data, in one embodiment, can be referred to as fact or associative data. Fact data is hard data and associative data is soft data. Fact data is designated by an “F”, and associative data is designated by an “A”. Fact data is data that is already available. Associative data is data that is not already available, and must be built (e.g., through research).

As illustrated in FIG. 4, in one embodiment, data can also be designated as a high, medium, or low quality, which indicates how closely the data is tied to a person. On FIG. 4, high quality data is indicated by an “H”, medium quality data is indicated by, a “M” and low quality data is indicated by an “L”. High quality data is data that is closely tied to a person and easy to verify as authentic, such as a name and current address. Medium quality data is data that is harder to verify as authentic, such as a social security number, which can be bought on the black market. Low quality data is data that is very hard to verify as authentic, such as non-official documents, such as a library card, which is very easy to forge.

As illustrated in FIG. 4, in one embodiment, the source of the data can also be designated. If the data is verified with a drivers license, this can be designated as the source “D/L”. If the data is verified by a partner's records or a third-party database, with a partner being another entity (e.g., Equifax, Choice Point), this is designated as “Third-Party D/B”. If the data is verified in-house, such as by creating and maintaining a database of information that is not readily available form other sources, this is designated as “D/B” for database. If the data is verified by using an entity's records, and the entity is a recognized government or other entity, this is designated by using the entity's name. For example, an amateur radio call sign is available by consulting a published database of the Federal Communications Commission (“FCC”). Thus, in FIG. 4, this information is designated as having an “FCC” source.

The applicant can be required to answer all the questions, or a randomly generated list of questions. The questions can be continually changed from one person to the next, or from time to time, as an added level of security. The applicant personal data may also include a password or personal identification number or identifier.

At 240, the applicant personal data is either verified on the spot and a card is issued with the biometric data, as shown in 230 and 235, or the applicant personal data is prepared and sent to a verification entity, which can be an inside or outside entity. Satisfactory verification of all or most hard data from existing data sources in real-time enables immediate issuing of an identity verification instrument 110 (e.g., a card) with an initial level of security. Unverified hard and/or soft data may require additional verification (e.g., manual verification by placing calls or doing additional research), and, once completed, establishes a higher level of security for the identity verification instrument 110. Failure of any data to be verified can be used to flag the identity as suspect. This information is valuable for those wishing to know the degree of authenticity and/or completeness of a certain identity.

The additional verification performed by a verification entity can include, but is not limited to, the following measures: having a third-party entity (e.g., Equifax, Choice Point) verify the information; verifying the information with information received from a third-party entity (e.g., phone company, credit card company).

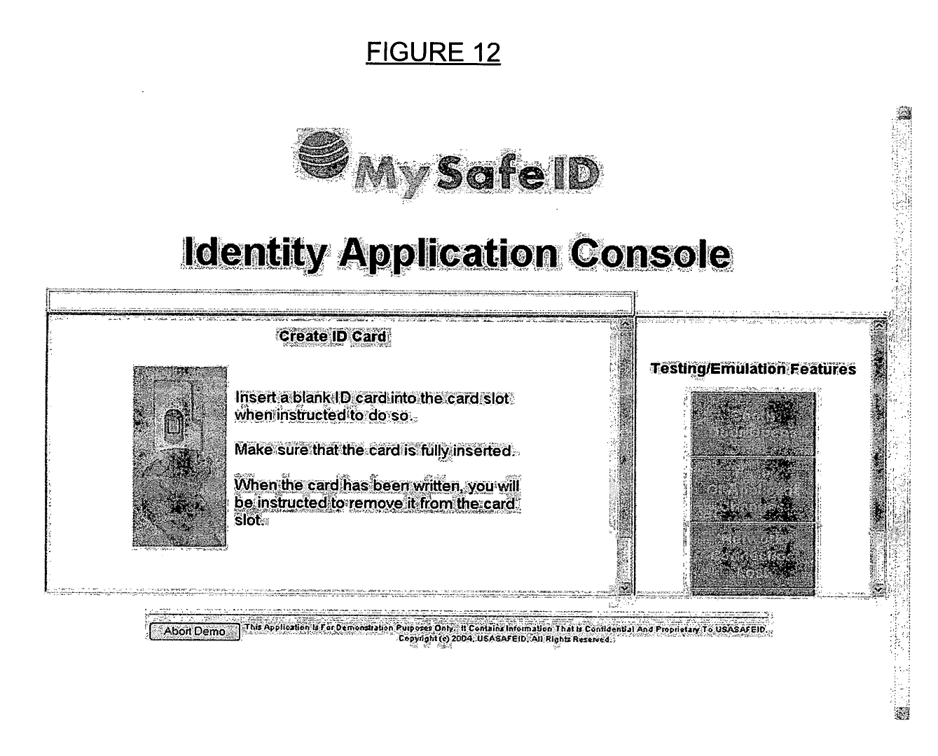

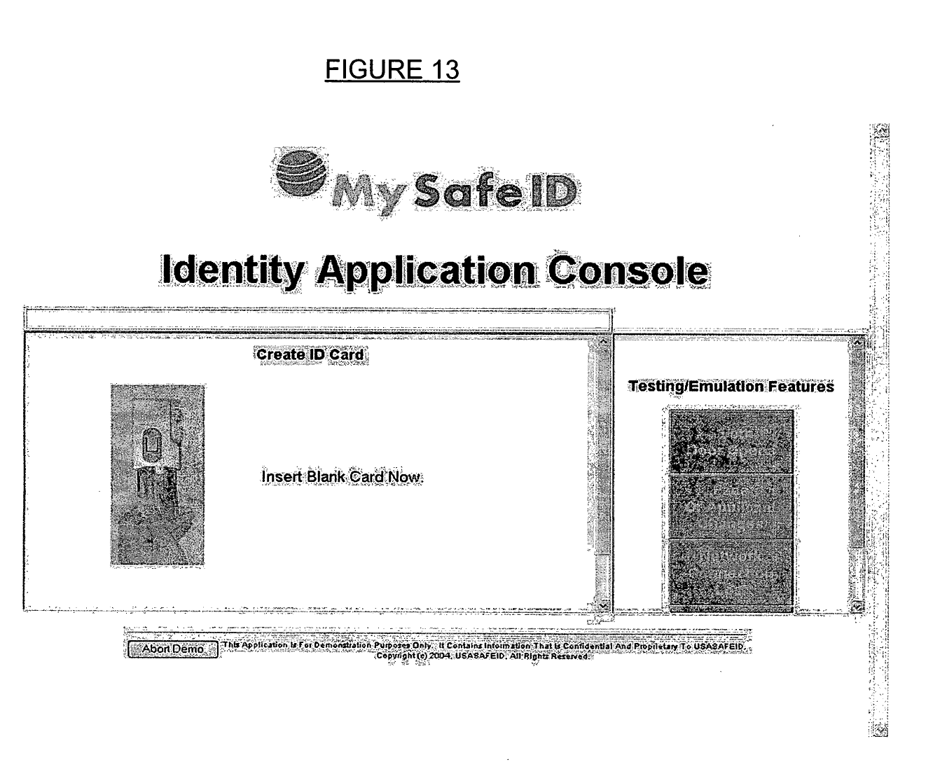

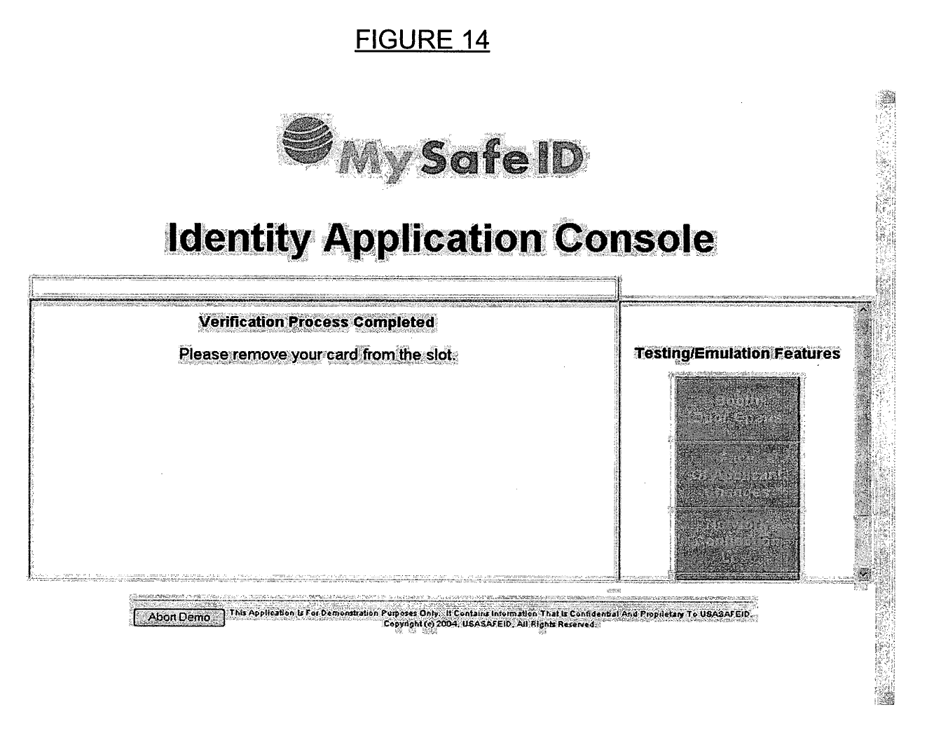

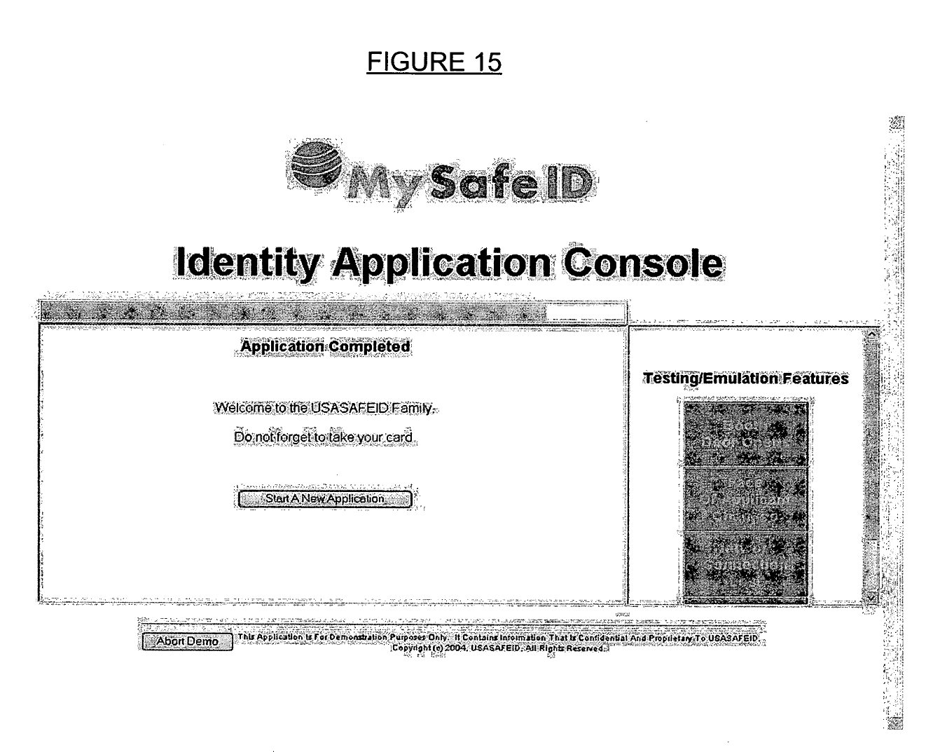

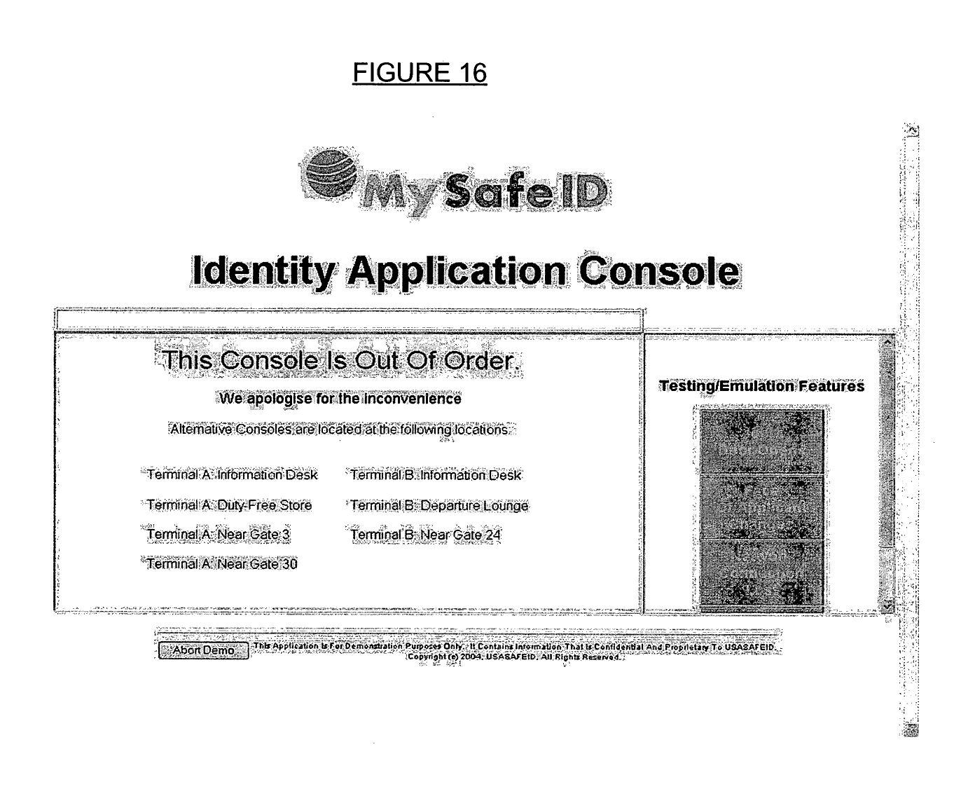

FIGS. 12-15 illustrate a card being issued on the spot. FIG. 16 is a sample error message.

At 245, the applicant personal data are examined by the verification entity to determine if the personal data matches numerous information databases. Numerous databases can be accessed in this process.

At 250, the data is evaluated against “hard” information to determine whether an identification verification instrument 110 should be issued. If there are an inadequate number of matches, an identification verification instrument 110 is not issued at 255. If there are an adequate number of matches, the identity of the user is determined to be valid at 260. Hard information comprises, but is not limited to, readily available information such as public or known historical information (e.g., full or partial credit card numbers, past addresses). Hard information can include, but is not limited to: information from the American Bankers Association, Equifax, Axciom, ChoicePoint, TransAmerica, and other financial institutions; driver's license information; or criminal record information; or any combination of the above.

At 265, a decision is made whether additional “soft” information should be verified. Soft information can include, but is not limited to, less readily available information, such as information gained from sources other than historical information. Soft information is important because public records, friends, or casual acquaintances rarely have access to this type of information. Soft information can include, but is not limited to: birth hospital name and location; elementary school name and location; junior high/middle school name and location; high school name and location; or church name and location; or any combination thereof. Sources for soft data can include, but are not limited to: U.S. hospitals; U.S. cities and townships; U.S. counties; U.S. Schools; housing records; deed, title, and property tax records; marriage and divorce records; and mapping services to correlate existence of past addresses; or multiple informational Web sites; or any combination thereof. If soft information cannot be correlated from existing records systems, then manual searches may be implemented to strengthen the pool of available data.

Depending on whether the soft information is verified at 265, the identity verification instrument 110 with different confidence levels is issued at 270 and 280. Those experienced in the art will realize that one, two, or more confidence levels may be issued for the identification verification instrument 110.

At 285, a criminal background check may be run, and if passed, the identification verification instrument 110 may issue with at least one additional higher level of confidence.

The confidence levels can be of any configuration. For example, in one embodiment, Level 1 represents “verified against hard sources”. Level 2 represents “verified against hard and soft sources”. Level 3 represents “verified against hard and soft sources and passage of a criminal background check”.

In one embodiment, only biometric and basic identification information is stored on the identification verification instrument 110. This small amount of information that needs to be stored allows an identification verification instrument 110 with little memory to be used. In addition, tampering with the instrument 110 will not reveal any important or private personal information. Furthermore, once the identification verification instrument 110 is issued, the personal information is destroyed, further increasing security and privacy.

Utilization Process. In one embodiment, identity verification can be done in order to allow access, admission, authentication or authorization to places and/or services. The verification can also be done to complete personal, legal or financial transactions, and/or to associate an individual's identity with the possession, location or disposition of properties, possessions or instruments. Those experienced in the art will realize that multiple additional uses are also possible.

Embodiments of the present invention may be used in, for example, but not limited to, the following applications: airline passenger ticketing, baggage check-in/claim, security screening and boarding processes; online/e-commerce transactions via the public Internet/World Wide Web; point-of-sale credit/debit card identity verification; private and public network access authentication; confirmation of identity claims presented by paper documents; certification of identity for greater trust relationship through online dating services; use as an entitlement mechanism for access control in conventional physical and electronic security systems; use as an employer identification system; use as an immigration identification system; or any combination thereof.

Utilization of the identification verification instrument 110 requires an identity verification station. This station matches information from a person at the station to the information on the identification verification instrument 110. This information could be biometric information, password information, and/or other information.

In one embodiment, the use of the identification verification instrument 110 and its match or failure to match is transmitted to and recorded by a central system, either directly to the host main server 123, or to the host main server 123 through another server. The central system maintains logs of all system activity and uses it to monitor for operational status and tampering. The server shares information with a user pertinent to the purpose of the identity verification, sent back from the host main server 123 on a case-by-case, client-by-client basis. This information is dependent on use and includes, but is not limited to: passing specific minimal user identity to a transportation system ticketing, baggage tagging, boarding, deplaning or baggage claim system; passing specific minimal user identity to a transaction processing system to match a transaction document (e.g., debit or credit card, check) with the bearer/presenter; passing user-selected personal or preference information to in-store or on-line marketing data collection systems; or passing specific minimal user identity to a physical or network access security system to operate locks or provide access to data; or any combination thereof.

The servers will retain sufficient identity and biometric information to maintain an individual's account and validate their identity as needed. The servers may provide, retain, and share as much or as little personal information as is appropriate for the transactions performed and the relationships the user has with others.

The user will be able to select and change, on a client-by-client, use-by-use relationship basis, which information goes to each respective user system by indicating this in the host web server for user data sharing selections 126. This includes minimal information needed in order to use the system, for example, for travel or financial purposes, although the users may opt out of using these services, and thus not provide access to the required information. For example, a user may decline to use the identification verification instrument 110 for credit card services, but decline to use it for travel services.

The servers will be employed to concentrate and buffer data from multiple stations enroute to the main server, as well as accept and distribute identity information required (e.g., for travel or financial services). The servers will not pass information back to the stations.

In one embodiment, the systems used to perform the verification, and create and issue the identification verification instrument 110 will be limited to locations with a vested interest in high-trust identification processes. Verification, issuance and subsequent use will be restricted to inter-operability within the overall system, limiting the ability to verify, issue and read the identification data to only those authorized to do so. The data used in the verification process will be from existing known, secure systems that cannot be easily compromised.

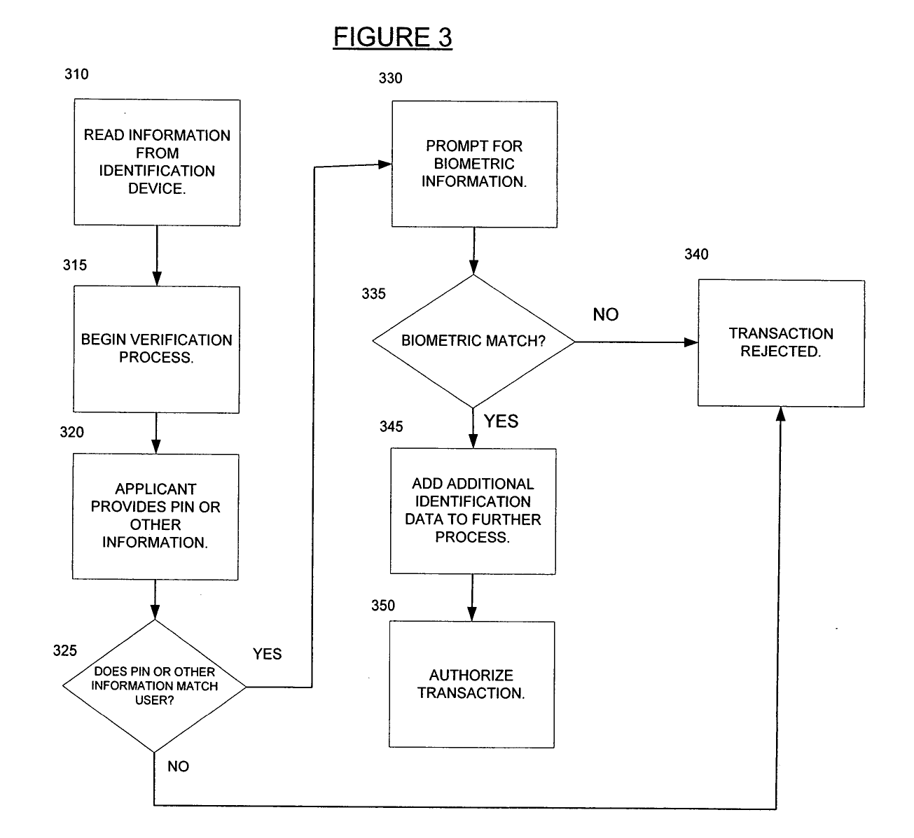

FIG. 3 illustrates a method of utilization, according to one embodiment of the invention. At 305, the identification verification instrument 110 is presented, and then read at 310. At 315, the verification process begins. The individual is prompted for a password, biometric data, and/or answers to questions. At 320, the individual provides a password or other data. At 325, the password is checked to ensure that it matches the individual. At 330, the identification is checked by prompting for biometric data. At 335, it is determined if the biometric data on the identification verification instrument 110 matches the individual's biometric data. If not, the transaction is rejected at 340. If so, additional data can be requested as further identification at 345. For example, the individual could be asked to provide his high school information. If the individual correctly provides the additional data, at 350 the transaction is authorized. If not, it is rejected at 340.

It should be noted that FIG. 3 illustrates one embodiment of the invention. In other embodiments, various information can be provided, such as a PIN or password, biometric data, or answers to personal questions, or any combination thereof. All this information does not need to be used, and either the host, or user, or both can determine which information to include and request in order to use the identification verification instrument 110.

Additional Features. In one embodiment, the present invention is used to create an identification verification instrument 110 that is very difficult to forge or duplicate. In order to obtain the identification verification instrument 110, a user will need to answer multiple questions based on hard and soft data. It is highly unlikely that anyone other than a specific individual will be able to create or assume a false identity based on casual or publicly available knowledge about that individual. In addition, it is highly unlikely that an individual or entity can create a false record of prior history and information for the purpose of creating or assuming a false identity. Cumulative information and records representing the life of an individual cannot be easily assumed, acquired or fabricated by others.

In addition, in one embodiment, once the identification verification instrument 110 is issued, it will be very difficult for an individual to use unless that individual was actually issued the identification verification instrument 110. The PIN or password, biometric data, and/or answers to personal questions will be difficult, if not impossible, for a person to discover.

In one embodiment, unnecessary and invasive profiling, background checks, and/or tracking of properly identified individuals are avoided. In addition the privacy and integrity of an individual's identity, and personal, financial, and legal and other business is preserved.

Rather than performing a cursory check verifying an identity, based on information such as paper instruments, credit histories, criminal background data, etc., information is obtained that is not readily available by public information, theft, and/or casual inspection of an individual's home, office, or computer records or discarded papers. Rather, lesser known historical and other information specific to individuals is used. In addition, the use of false or predictable data about individual is precluded.

In one embodiment, parties may verify an individual's identity without actually performing the validation themselves. Individuals are provided with a secure identification verification instrument 110 that cannot easily be tampered with to provide personal information to others without having to reveal inappropriate or excessive personal information. In addition, an individual can be cross-checked against other identity and database systems without subjecting them to tracking, flagging or exposure of personal information. Furthermore, efforts of personal identity theft, and identity and transaction fraud are thwarted.

In one embodiment, information may be stored as changeable or not changeable. Information that cannot be changed is stored in a manner where it cannot be altered or tampered with to preclude later falsification or creation of fictitious records. Information that is not changeable includes, but is not limited to, historical information. Information that may be changed is stored as selectively changeable under the appropriate authority.

Information that is changeable comprises, but is not limited to: full name, current residence (address, phone), driver's license information, passport information, or social security number, or any combination of the above. Biometric data may also be changed under the appropriate authority to provide for significant changes in physical characteristics. Changeable information also comprises, but is not limited to: at least one password, at least one personal identification number (PIN), or at least one select personal identifier, or any combination thereof.

By verifying an individual's identity and limiting access to personal data under the individual's control, such verification will be highly-trusted and uncompromised. Thus, data is not exposed to the entity requiring identification (e.g., airline, government). Verification is not done with an existing database that records and tracks queries for a variety of unrelated pattern analysis. The identification verification instrument 110 does not reveal an individual's personal information beyond a verified identity, and will not track identity verification queries. Identity verification will be determined from cumulative sources of public and private records, providing more points of assurance and trust than other readily forged documents.

In one embodiment, special endorsements and/or additional qualifiers can be added to the data stored on or related to the identity verification instrument 110 for specific interests and purposes. For example, a certification (e.g., number, stamp) by a financial institution or security interest can be added to the identity verification instrument 110 (such as the additional 3-digit security code added to some credit cards). This can provide information that a specific issuer/agent has witnessed the identity verification instrument 110 in their presence so that it can be accepted as a highly trusted authentication at a later date.

In other embodiments, additional validating certificates and/or keys can be provided to indicate that the identity verification instrument 110 comes from one or more services and that the identity verification instrument 110 allows access to those services with or without using host systems. Specific certificates and/or keys may be applied for varying levels and types of data release. In other words, information can be included on the identity verification instrument 110 and/or kept at a host or other system. In this way, the user can control how the identity verification instrument 110 is used and what personal data is shared, and with whom. For example, a user may wish to have their identity verified when buying something on-line. In this case, a biometric terminal and a reader can be attached to a computer so that the on-line transaction can be allowed based on the verification of the presence of the owner of the identity verification instrument 110 and/or credit or debit card. In addition, a person may have entitlement information stored on or related to an identity verification instrument 110 allowing access to certain medical records and other identity or authorizing documents, so that valuable life-saving information can be provided without further authentication. Such information could indicate a person's wish to release medical data without next-of-kin or guardian authorization if the person were unconscious or incapacitated. Furthermore, entitlement information could be stored on or related to the identity verification instrument 110 allowing access to certain computer programs or records.

Conclusion. The foregoing description should be considered as illustrative only. The invention may be configured in a variety of shapes and sizes and is not limited by the dimensions of the disclosed embodiments. Numerous applications of the invention will readily occur to those skilled in the art. Therefore, it is not desirous to limit the invention to the specific embodiments disclosed or the exact construction and operation shown and described. Rather, all suitable modifications and equivalents may be resorted to, falling within the scope of the invention.

In addition, it should be understood that the figures, which highlight the functionality of the present invention, are presented for example purposes only. The architecture of the present invention is sufficiently flexible and configurable, such that it may be utilized in ways other than that shown in the accompanying figures.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope of the present invention in any way.

What is claimed is:

1. A method of issuing an identification verification instrument verifying the identification of at least one individual, comprising:
collecting multi-faceted personal information about the at least one individual;
generating verification information by verifying the personal information; and
issuing at least one identification verification instrument if the verification information has met a predetermined level of verification;
designating multiple levels of confidence for the identification verification instrument based on the verification information.

2. The method of claim 1, further comprising verifying the identity of the at least one individual using the identification verification instrument.

3. The method of claim 1, further comprising collecting subsequent information, comprising:
biometric information; or
a password; or
a personal identification number (PIN); or
additional personal information; or
non-forgeable data; or
any combination thereof.

4. A method of verifying the identity of at least one individual, comprising:
collecting information from an identification verification instrument provided by the at least one individual, the identification verification instrument being issued after collecting multi-faceted personal information about the at least one individual;
collecting subsequent information from the at least one individual;
comparing the information from the identification verification instrument and the subsequent information to determine if the identity of the at least one individual is verifiable.
designating multiple levels of confidence for the identification verification instrument based on the verification information.

5. The method of claim 4, wherein at least part of the verification information is destroyed after the identification verification instrument is issued.

6. The method of claim 4, wherein the subsequent information is:
biometric information; or
a password; or
a personal identification number (PIN); or
additional personal information; or
non-forgeable data; or
any combination thereof.

7. The method of claim 1, wherein the at least one individual authorizes the personal information that will be provided to outside parties.

8. The method of claim 4, wherein the at least one individual authorizes the personal information that will be provided to outside parties attempting to verify the identity of the at least one individual.

9. The method of claim 1, wherein the personal information comprises hard and soft personal information, the hard personal information readily available to the public, and the soft personal information not readily available to the public.

10. The method of claim 4, wherein the personal information comprises hard and soft personal information, the hard personal information readily available to the public, and the soft personal information not readily available to the public.

11. A computer program product comprising a computer usable medium having control logic stored therein for causing a computer to issue an identification verification instrument verifying the identification of at least one individual, the control logic comprising:
first computer readable program code means for collecting multi-faceted personal information about the at least one individual;
second computer readable program code means for generating verification information by verifying the personal information;
third computer readable program codes means for issuing at least one identification verification instrument if the verification information has met a predetermined level of verification; and
fourth computer readable program means for designating multiple levels of confidence for the identification verification instrument based on the verification information.

12. The computer program product of claim 11, further comprising fourth computer readable program means for verifying the identity of the at least one individual using the identification verification instrument.

13. The computer program product of claim 11, wherein at least part of the verification information is destroyed after the identification verification instrument is issued.

14. The computer program product of claim 11, further comprising fourth computer readable program means for collecting subsequent information, comprising:
biometric information; or
a password; or
a personal identification number (PIN); or
additional personal information; or
non-forgeable data; or
any combination thereof.

15. A computer program product comprising a computer usable medium having control logic stored therein for causing a computer to verify the identity of at least one individual, the control logic comprising:
first computer readable program means for collecting information from an identification verification instrument provided by the at least one individual, the identification verification instrument being issued after collecting multi-faceted personal information about the at least one individual;
second computer readable program means for collecting subsequent information from the at least one individual;
third computer readable program means for comparing the information from the identification verification instrument and the subsequent information to determine if the identity of the at least one individual is verifiable; and
fourth computer readable program means for designating multiple levels of confidence for the identification verification instrument based on the verification information.

16. The computer program product of claim 15, wherein at least part of the verification information is destroyed after the identification verification instrument is issued.

17. The computer program product of claim 15, wherein the subsequent information is:
biometric information; or
a password; or
a personal identification number (PIN); or
additional personal information; or
non-forgeable data; or
any combination thereof.

18. The computer program product of claim 11, wherein the at least one individual authorizes the personal information that will be provided to outside parties.

19. The computer program product of claim 15, wherein the at least one individual authorizes the personal information that will be provided to outside parties attempting to verify the identity of the at least one individual.

20. The computer program product of claim 11, wherein the personal information comprises hard and soft personal information, the hard personal information readily available to the public, and the soft personal information not readily available to the public.

21. The computer program product of claim 15, wherein the personal information comprises hard and soft personal information, the hard personal information readily available to the public, and the soft personal information not readily available to the public.

22. A system for issuing an identification verification instrument verifying the identification of at least one individual, comprising:
an input device for accepting multi-faceted personal information about the at least one individual;
a verification device for generating verification information by verifying the personal information;
an issuance device for issuing at least one identification verification instrument if the verification information has met a predetermined level of verification; and
a designation device for designating multiple levels of confidence for the identification verification instrument based on the verification information.

23. The system of claim 22, further comprising a verification device for verifying the identity of the at least one individual using the identification verification instrument.

24. The system of claim 22, wherein at least part of the verification information is destroyed after the identification verification instrument is issued.

25. The system of claim 22, further comprising an input device for collecting subsequent information, comprising:
biometric information; or
a password; or
a personal identification number (PIN); or
additional personal information; or
non-forgeable data; or
any combination thereof.

26. A system of verifying the identity of at least one individual, comprising:
an input device for accepting personal information from an identification verification instrument provided by the at least one individual, the identification verification instrument being issued after collecting multi-faceted personal information about the at least one individual;
an input device for collecting subsequent information from the at least one individual;
a comparison device for comparing the information from the identification verification instrument and the subsequent information to determine if the identity of the at least one individual is verifiable; and
a designation device for designating multiple levels of confidence for the identification verification instrument based on the verification information.

27. The system of claim 26, wherein at least part of the verification information is destroyed after the identification verification instrument is issued.

28. The system of claim 26, wherein the subsequent information is:
biometric information; or
a password; or
a personal identification number (PIN); or
additional personal information; or
non-forgeable data; or
any combination thereof.

29. The system of claim 22, wherein the at least one individual authorizes the personal information that will be provided to outside parties.

30. The system of claim 26, wherein the at least one individual authorizes the personal information that will be provided to outside parties attempting to verify the identity of the at least one individual.

31. The system of claim 22, wherein the personal information comprises hard and soft personal information, the hard personal information readily available to the public, and the soft personal information not readily available to the public.

32. The system of claim 26, wherein the personal information comprises hard and soft personal information, the hard personal information readily available to the public, and the soft personal information not readily available to the public.

33. The method of claim 1, further comprising collecting subsequent information, comprising biometric information.

34. The method of claim 4, wherein the subsequent information is biometric information.

35. The computer program product of claim 11, further comprising fourth computer readable program means for collecting subsequent information, comprising biometric information.

36. The computer program product of claim 15, wherein the subsequent information is biometric information.

37. The system of claim 22, further comprising an input device for collecting subsequent information, comprising biometric information.

38. The system of claim 26, wherein the subsequent information is biometric information.

39. A method of issuing an identification verification instrument verifying the identification of at least one individual, comprising:
collecting personal information about the at least one individual;
generating verification information by verifying the personal information; and
issuing at least one identification verification instrument if the verification information has met a predetermined level of verification;
wherein the personal information comprises hard and soft personal information, the hard personal information readily available to the public, and the soft personal information not readily available to the public.

40. A method of issuing an identification verification instrument verifying the identification of at least one individual, comprising:
collecting personal information about the at least one individual;
generating verification information by verifying the personal information; and
issuing at least one identification verification instrument if the verification information has met a predetermined level of verification;
wherein at least part of the verification information is destroyed after the identification verification instrument is issued.

41. A method of issuing an identification verification instrument verifying the identification of at least one individual, comprising:
collecting personal information about the at least one individual;
generating verification information by verifying the personal information; and
issuing at least one identification verification instrument if the verification information has met a predetermined level of verification;
wherein the at least one individual authorizes the personal information that will be provided to outside parties attempting to verify the identity of the at least one individual.
